(19) United States
(12) Patent Application Publication
(10) Pub. No.: US 2010/0265062 A1
(43) Pub. Date: Oct. 21, 2010

(54) ENVIRONMENTAL MONITORING SYSTEM AND MONITORING METHOD USING THE SAME

(75) Inventor: TSUNG-HUI KU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/685,042

(22) Filed: Jan. 11, 2010

(30) Foreign Application Priority Data
Apr. 21, 2009 (CN) 200910301725.3

(51) Int. Cl. G08B 1/08

(52) U.S. Cl. 340/539.26

(57) ABSTRACT

An exemplary embodiment of environmental monitoring system includes a base station, a monitoring control device and a monitor device. The monitoring device is communicated with the monitoring control device and the base station by wireless communication network. The monitoring control device sets monitoring instructions and sends the monitoring instructions to the base station in the form of short message using wireless communication network. The monitoring device receives the monitoring instructions in the form of short messages, generates corresponding monitoring data according to the monitoring instructions to obtain corresponding monitoring results, and transmits the monitoring results to the base station and the monitoring control device in the form of short messages.

### BACKGROUND

1. Technical field

The disclosure generally relates to environmental monitoring systems and methods, particularly, to an environmental monitoring system and an environmental monitoring method for rapidly transmitting environmental information.

2. Description of the Related Art

Environmental conditions, such as temperature, humidity, radiation intensity, are constantly changing. Therefore, it is necessary to real-time monitor environmental conditions.

People generally use expensive environmental monitoring equipment to monitor living environments, and some special communication equipments and networks, such as public switched telephone network (PSTN), global position system (GPS), are utilized to transmit the environmental information. However, installing and laying the environmental monitoring equipments and special communication networks can be expensive.

Therefore, there is room for improvement within the art.

### BRIEF DESCRIPTION OF THE DRAWINGS

Many aspects of an environmental monitoring system and monitoring method using the same can be better understood with reference to the following drawings. The components in the drawings are not necessarily drawn to scale, the emphasis instead being placed upon clearly illustrating the principles of the exemplary environmental monitoring system and monitoring method using the same. Moreover, in the drawings, like reference numerals designate corresponding parts throughout the several views. Wherever possible, the same reference numbers are used throughout the drawings to refer to the same or like elements of an embodiment.

FIG. 1 is a block diagram of an environmental monitoring system, according to an exemplary embodiment.

FIG. 2 is a flow chart illustrating an environmental monitoring method, according to an exemplary embodiment.

### DETAILED DESCRIPTION

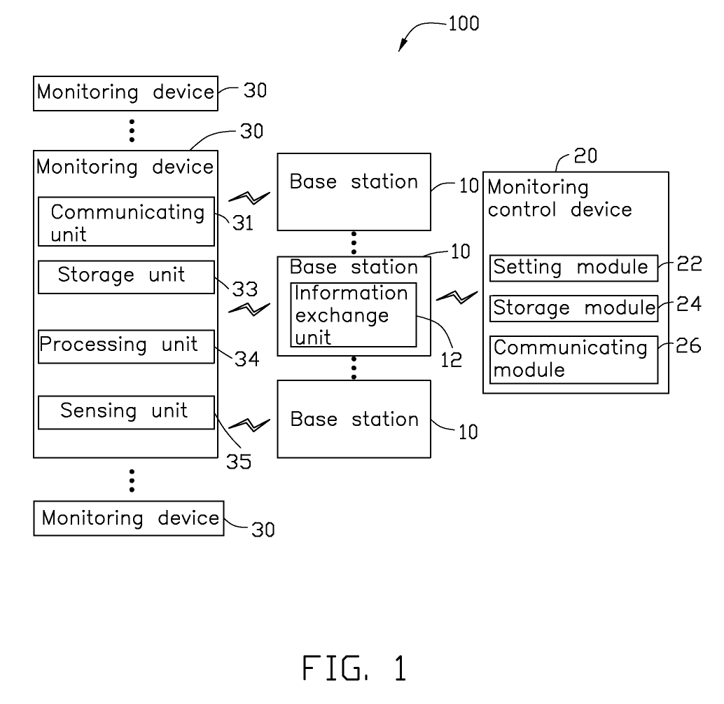

FIG. 1 shows an exemplary embodiment of an environmental monitoring system 100 for use with a wireless communication network such as a GSM network to transmit environmental information in the form of short messages. The environmental monitoring system 100 includes a plurality of base stations 10, a monitoring control device 20, and a plurality of monitoring devices 30.

Each base station 10 wirelessly communicates with the monitoring control device 20 and the monitoring devices 30 using the GSM network. Each base station 10 includes an information exchange unit 12. The monitoring control device 20 sends monitoring instructions to the monitoring devices 30 by the information exchange unit 12 in the form of short messages and the monitoring devices 30 send monitoring results to the monitoring control device 20 by the information exchange unit 12, also in the form of short messages.

The monitoring control device 20 sends monitoring instructions, receives monitoring results, and processes the monitoring results. The monitoring control device 20 includes a setting module 22, a storage module 24, and a communicating module 26. The setting module 22 is electrically connected to the storage module 24 and the communicating module 26.

The setting module 22 is configured for establishing environmental monitoring instructions related to such conditions as temperature, humidity, monitoring frequency, etc. A monitoring instruction might be, for example, “get current temperature”. The setting module 22 can be a typical operating device, such as a control panel. The storage module 24 is a memory for storing the environmental monitoring instructions set by the setting module 22 and storing the environmental monitoring results sent from the information exchange unit 12 of the base station 12. The communicating module 26 is configured for sending the monitoring instructions established by the setting module 22 to the information exchange unit 12 and receiving the monitoring results from the information exchange unit 12. The storage module 24 can be integrated within an existing memory storage device, such as a flash, etc. The communicating unit 26 can be integrated with an existing wireless transmission device, such as a GSM antenna.

The monitoring devices 30 are located in or moved into the region to be environmentally monitored, and each monitoring device 30 includes a communicating unit 31, a storage unit 33, a processing unit 34, and a sensing unit 35. The processing unit 34 is electrically connected to the communicating unit 31, the storage unit 33, and the sensing unit 35.

The communicating unit 31 controls the receiving and sending of the monitoring instructions from the information exchange unit 12 and sends the monitoring results to the information exchange unit 12. When received by the communicating unit 31, the monitoring instructions are stored in the storage unit 33. The communicating unit 31 can be a GSM Modem for programmably controlling to send and receive short messages. The storage unit 33 can be integrated with an existing subscriber identity model (SIM).

The processing unit 34 is configured for reading and processing the monitoring instructions stored in the storage unit 33, resulting in commanding the sensing unit 35 to obtain specific environmental monitoring data of the immediate area around the sensors. The sensing unit 35 can be combined with a humidity sensor, a temperature sensor, a gas sensor, a light sensor, etc. The sensing unit 35 with high sensitivity is disposed on the exterior of each monitoring device 30 to monitor the surrounding environment.

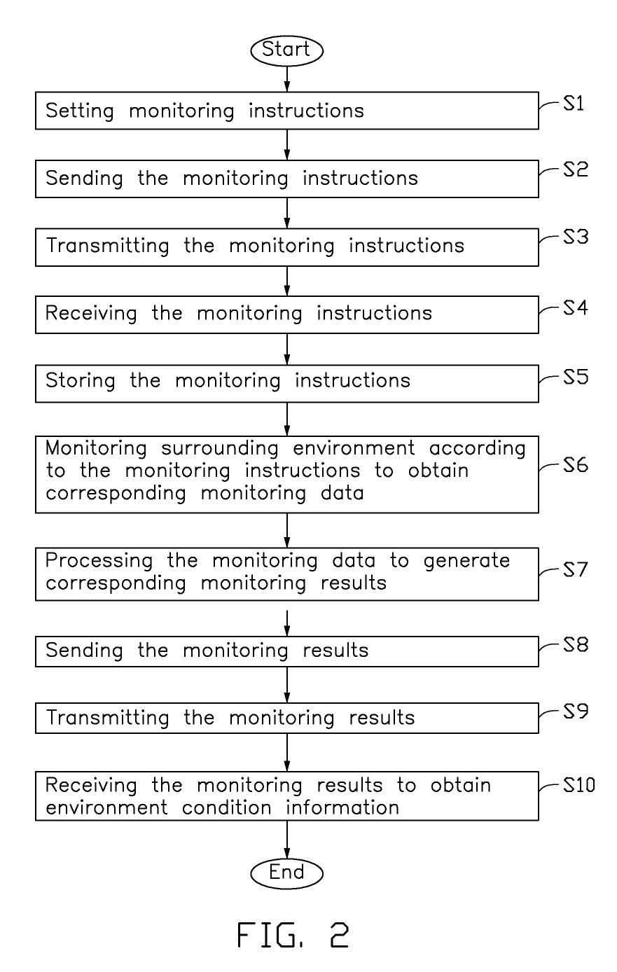

Further referring to FIG. 2, an environmental monitoring method in accordance with an exemplary embodiment is depicted. The environmental monitoring method may use the environmental monitoring system 100 to monitor environmental conditions and to communicate over a GSM network. The environmental monitoring method may at least include the following steps.

In step S1, the monitoring instructions including such as, “get temperature”, “measure humidity”, or related to monitoring frequency etc. for each monitoring device 30 are set by the setting module 22 of the monitoring control device 20.

In step S2, the monitoring instructions are wirelessly sent to the information exchange unit 12 of the base station 10 by the communicating module 26 in the form of short messages using the GSM network.

In step S3, the monitoring instructions are wirelessly transmitted from the information exchange unit 12 to the communicating unit 31 of the monitoring device 30 in the form of short messages using the GSM network.

In step S4, the monitoring instructions are received by the communicating unit 31 and transmitted to the storage unit 33.

In step S5, the monitoring instructions are stored in the storage unit 33 under the control of corresponding processing unit 34.

In step S6, the processing unit 34 reads and processes the monitoring instructions stored in the storage unit 33 to command corresponding sensing units 35 of the monitoring device 30 to monitor surrounding environmental according to the monitoring instructions to generate corresponding monitoring data.

In step S7, The processing unit 34 receives and processes the monitoring data from the sensing unit 35 to obtain corresponding monitoring results.

In step S8, the monitoring results from the sensing unit 35 are wirelessly sent from the communicating unit 31 to the information exchange unit 12 of the base station 10 using the GSM network and short messages.

In step S9, the monitoring results from the sensing unit 35 are wirelessly transmitted from the information exchange unit 12 to the communicating module 26 using the GSM network and short messages.

In step S10, the communicating module 26 receives and stores the monitoring results from the information exchange unit 12.

In the environmental monitoring system 100 and monitoring method using the same of the exemplary embodiment, the communicating module 26 transmits the established monitoring instructions to the base stations 10 using the GSM network and short messages. The base stations 10 transmit the monitoring instructions to each monitoring device 30 in the form of short messages, such that the sensing unit 35 monitors surrounding environmental under the control of the processing unit 34, and the monitoring results are wirelessly sent to the monitoring control device 20 using the GSM network and short messages. Thus, the environmental monitoring system 100 wirelessly transmits monitoring instructions and monitoring results in the form of short messages by using an existing GSM network, without special cable networks and expensive communication equipments, resulting in reducing cost of environmental monitoring and being easy to use.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. An environmental monitoring system, comprising:
a base station;
a monitoring control device wirelessly communicating with the base station, setting monitoring instructions and sending the monitoring instructions to the base station in the form of short message using a wireless communication network; and
a monitoring device wirelessly communicating with the monitoring control device and the base station by using the wireless communication network, and receiving the monitoring instructions in the form of short messages, wherein the monitoring device generates monitoring data according to the monitoring instructions to obtain corresponding monitoring results, and transmits the monitoring results to the base station and the monitoring control device in the form of short messages.

2. The environmental monitoring system as claimed in claim 1, wherein the base station includes an information exchange unit for receiving and transmitting the monitoring instructions and the monitoring results.

3. The environmental monitoring system as claimed in claim 2, wherein the monitoring device includes a communicating unit, the communicating unit is configured for receiving the monitoring instructions from the information exchange unit and sending the monitoring results to the information exchange unit.

4. The environmental monitoring system as claimed in claim 3, wherein the monitoring device further includes a storage unit for storing the monitoring instructions received by the communicating unit.

5. The environmental monitoring system as claimed in claim 4, wherein the monitoring device further includes a sensing unit for detecting surrounding environmental according to the monitoring instructions to generate corresponding monitoring data.

6. The environmental monitoring system as claimed in claim 5, wherein the monitoring device further includes a processing unit electrically connected to the communicating unit, the storage unit and the sensing unit, the processing unit is configured for reading the monitoring instructions stored in the storage unit, controlling the sensing unit to detect surrounding environment, and processing the monitoring data from the sensing unit to obtain corresponding monitor results.

7. The environmental monitoring system as claimed in claim 5, wherein the sensing unit is at least one of a humidity sensor, a temperature sensor, a gas sensor, or a light sensor.

8. The environmental monitoring system as claimed in claim 1, wherein the monitoring control device includes a setting module for establishing the monitoring instructions.

9. The environmental monitoring system as claimed in claim 8, wherein the monitoring control device further includes a storage module for storing the monitoring instructions set by the setting module and storing the monitoring results sent from the base station.

10. The environmental monitoring system as claimed in claim 9, wherein the monitoring control device further includes a communicating module electrically connected to the setting module and the storage module, the communication module is configured for sending the monitoring instructions to the base station.

11. The environmental monitoring system as claimed in claim 1, further including a plurality of base stations and monitoring devices, the monitoring control device communicates with the monitoring devices by the base stations using the wireless communication network.

12. An environmental monitoring method, comprising steps of:
setting monitoring instructions;
sending the monitoring instructions to a monitoring device;
storing the monitoring instructions in the monitoring device;
monitoring surrounding environmental conditions according to the monitoring instructions by the monitoring device to generate corresponding monitoring data; and
processing the monitoring data to obtain corresponding monitoring results.

13. The environmental monitoring method as claimed in claim 12, wherein the step of sending the monitoring instructions to a monitoring device includes a step of sending the monitoring instructions from a monitoring control device to a base station.

14. The environmental monitoring method as claimed in claim 13, wherein the step of sending the monitoring instructions to a monitoring device further includes a step of transmitting the monitoring instructions from the base station to the monitoring device.

15. The environmental monitoring method as claimed in claim 13, further including a step of sending monitoring results to the base station.

16. The environmental monitoring method as claimed in claim 15, further including a step of transmitting the monitoring results from the base station to the monitoring control device.

17. The environmental monitoring method as claimed in claim 16, further including a step of receiving the monitoring results by the monitoring control device.

18. The environmental monitoring method as claimed in claim 13, wherein the environmental monitoring system further including a plurality of base stations and monitoring devices, the monitoring control device communicates with the monitoring devices by the base stations using the wireless communication network.
